(19) United States
(12) Patent Application Publication
(10) Pub. No.: US 2009/0071759 A1
(43) Pub. Date: Mar. 19, 2009

(54) TRACTION DRIVE ELEVATOR

(75) Inventors: Zhigang YU, Shenyang (CN); Yunsong GU, Shenyang (CN); Hetong MAO, Shenyang (CN); Hongwen LI, Shenyang (CN); Junbin LI, Shenyang (CN)

Correspondence Address: MATTHIAS SCHOLL, 14781 MEMORIAL DRIVE, SUITE 1319, HOUSTON, TX, 77079, US

(73) Assignee: SHENYANG BRILLIANT ELEVATOR CO., LTD., Shenyang (CN)

(21) Appl. No.: 12/272,857

(22) Filed: Nov. 18, 2008

Related U.S. Application Data
(63) Continuation of application No. PCT/CN2006/001245, filed on Jun. 8, 2006.

(30) Foreign Application Priority Data
May 19, 2006 (CN) 200610081437.8

(51) Int. Cl. B66B 11/08

(52) U.S. Cl. 187/254

(57) ABSTRACT

A traction drive elevator, comprising: an elevator car, a pair of guide rails, a counterweight, a traction drive motor comprising a housing, a stator, a rotor and a traction sheave; wherein the guide rails are disposed in a hoistway; both ends of the housing are symmetrically fixed to a side wall of the hoistway; the housing operates as a bearing beam; and the elevator car and the counterweight are suspended on the traction sheave of the traction drive motor via a plurality of wire ropes. Since the traction drive motor occupies no additional vertical space in the hoistway, space utilization ratio of the vertical space in the hoistway is increased, the height of the top floor is decreased, and building materials are saved.

### CROSS-REFERENCE TO RELATED APPLICATIONS

This application is a continuation of International Patent Application No. PCT/CN2006/001245, with an international filing date of Jun. 8, 2006, designating the United States, now pending, which is based on Chinese Patent Application No. 200610081437.8, filed May 19, 2006. The contents of these specifications are incorporated herein by reference.

### BACKGROUND OF THE INVENTION

1. Field of the Invention

The invention relates to an elevator, and more particularly to a traction drive elevator.

2. Description of the Related Art

A conventional traction drive elevator consists of a pair of guide rails disposed in a hoistway, an elevator car traveling along one of the guide rails, a counterweight traveling along the other guide rail, and a traction drive motor comprising a stator, a rotor, and a traction sheave. The elevator car and the counterweight are suspended on the traction sheave via a plurality of wire ropes, and the traction sheave transfers force from the motor onto the wire ropes by friction and thus, the elevator car and the counterweight travel up and down in opposite movements. The traction drive motor is disposed in a machine room, which is conventionally located in the hoistway. As an improvement, another type of traction drive elevator uses a steel beam and a traction drive motor suspended thereon as an alternative to a machine room.

However, in both of the conventional designs, the drive motor assembly takes up too much space in the hoistway, and much opportunity exists for improved elevator designs.

### SUMMARY OF THE INVENTION

In view of the above-described problems, it is an objective of the invention to provide a traction drive elevator that features increased space utilization ratio and requires a decreased amount of building materials.

In order to achieve the above objectives, in accordance with one embodiment of the invention, provided is a traction drive elevator, comprising an elevator car, a pair of guide rails, a counterweight, a traction drive motor comprising a housing, a stator, a rotor and a traction sheave, wherein the guide rails are disposed in a hoistway, both ends of the housing are symmetrically fixed to a side wall of the hoistway, the housing operates as a bearing beam, and the elevator car and the counterweight are suspended on the traction sheave of the traction drive motor via a plurality of wire ropes.

In a class of this embodiment or in another embodiment, points where both ends of the housing to the side wall are disposed outside a vertical projection region of the elevator car.

In a class of this embodiment or in another embodiment, the housing is in a shape of a hollow column.

In a class of this embodiment or in another embodiment, a cross section of the housing is square, circular, triangular or elliptic.

In a class of this embodiment or in another embodiment, a mid-axis connecting the stator, the rotor and the traction sheave is parallel to that of the housing.

In a class of this embodiment or in another embodiment, a damping rubber pad is disposed between the housing and the side wall.

In a class of this embodiment or in another embodiment, a mid-axis connecting the stator, the rotor and the traction sheave coincides with that of the housing.

In a class of this embodiment or in another embodiment, the elevator further comprises a main anchor, an auxiliary anchor, and diversion sheaves, wherein one end of the wire ropes is fixed to the auxiliary anchor; the wire ropes pass through the counterweight sheave, the traction sheave, and the diversion sheaves; and the other end of the wire rope is fixed to the main anchor.

Since the stator, the rotor and the traction sheave are disposed in the housing, only does the housing take up vertical space in the hoistway, and the traction drive motor occupies no additional vertical space in the hoistway. Thus, space utilization ratio of the vertical space in the hoistway is increased, the height of the top floor is decreased, and building materials are saved.

### BRIEF DESCRIPTION OF THE DRAWINGS

Detailed description will be given below with reference to accompanying drawings, in which:

FIG. 1 is a perspective view of a traction drive elevator of one embodiment of the invention;

FIG. 2 is a front view thereof; and

FIG. 3 is a right side view thereof.

### DETAILED DESCRIPTION OF THE INVENTION

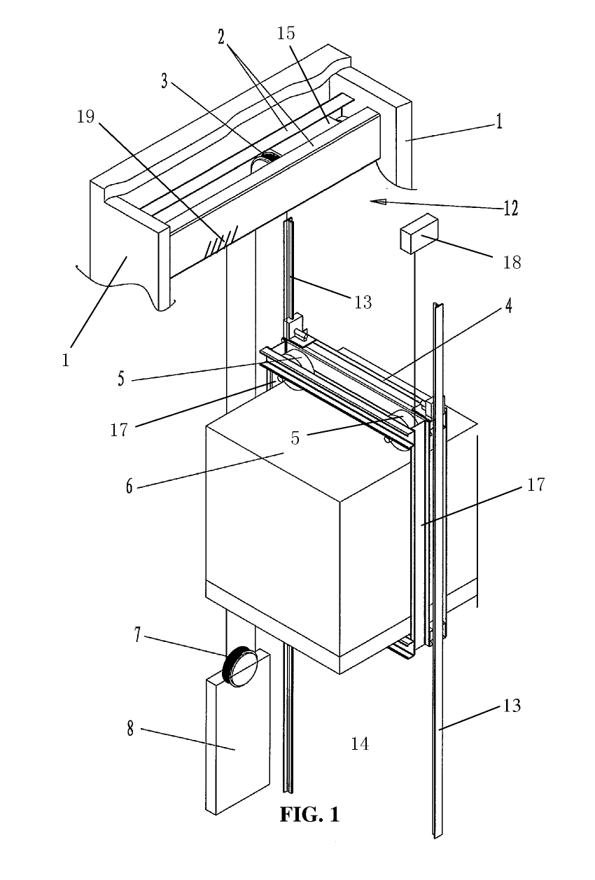

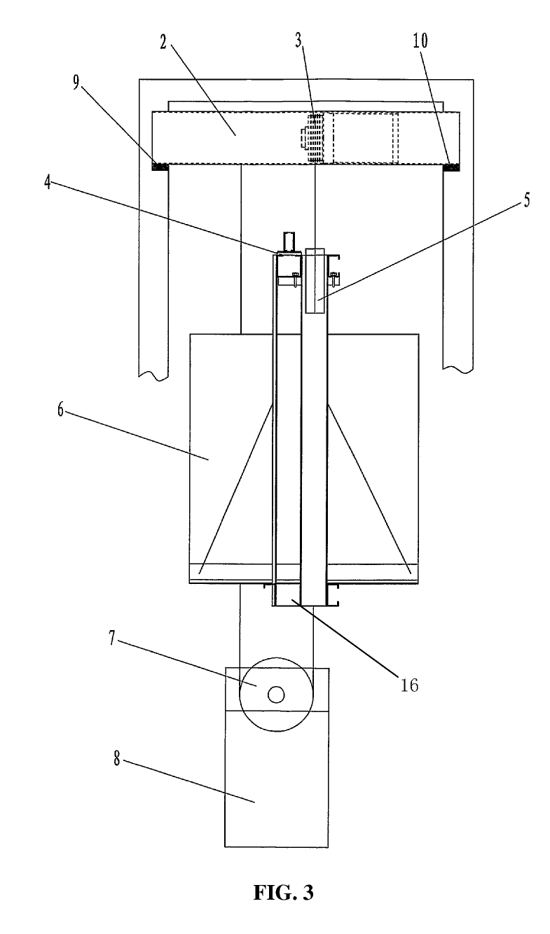

As shown in FIGS. 1-3, a traction drive elevator of the invention comprises a pair of guide rails 13 disposed in a hoistway 14, an elevator car 6, a counterweight 8 and a traction drive motor 15. The elevator car 6 travels along the guide rails. The traction drive motor comprises a housing 2, a stator, a rotor, and a traction sheave 3. Both ends of the housing 2 are symmetrically fixed to a side wall 1 of the hoistway. The stator, the rotor and the traction sheave 3 are disposed in the housing 2.

An elevator car frame comprising an upper beam 4, a lower beam 16, and a pair of columns 17 is disposed on the elevator car 6. A pair of diversion sheaves 5 is disposed on the upper beam 4.

A counterweight diversion sheave 7 is disposed on the counterweight 8.

A plurality of wire ropes passes though the diversion sheaves 5, the traction shave 3, and the counterweight diversion sheave 7, and suspends the elevator car 6 and the counterweight 8 on the traction sheave 3. One end of the wire ropes is attached to a first anchor 18, and the other end of the wire ropes is attached to a second anchor 19. The second anchor 19 is attached to the housing 2.

A damping rubber pad 9 is disposed between the housing and the side wall 1 of the hoistway, so as to alleviate transfer of vibrations of the traction drive motor onto buildings.

The width of the housing 2 is approximately the same as that of the hoistway, namely, it is the distance between the front wall and the back wall of the elevator.

The housing 2 also operates as a bearing beam, which houses the traction drive motor 15 having a height only slightly greater than a diameter of the traction sheave 3. Accordingly, the space utilization ratio in the hoistway is improved.

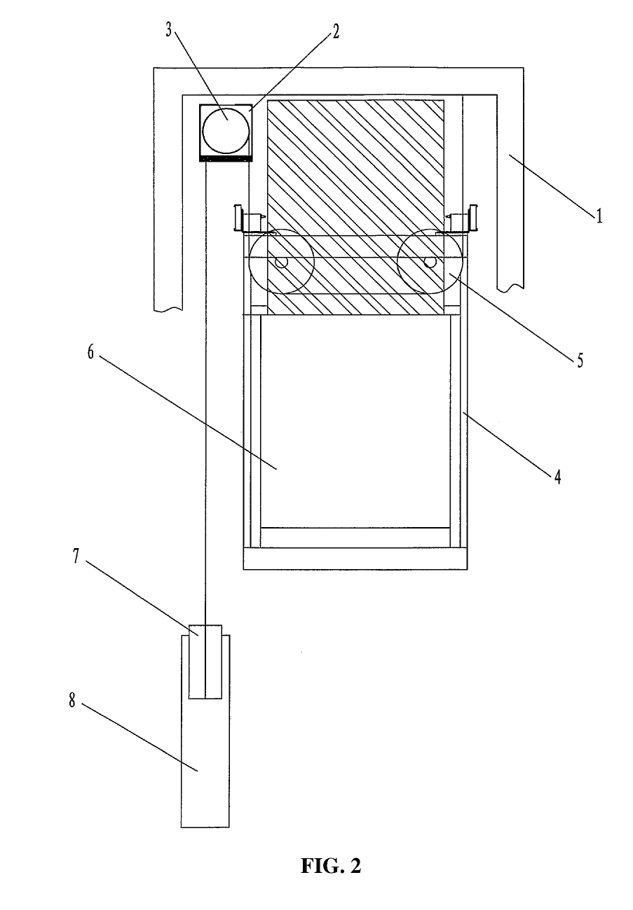

Points at which both ends of the housing 2 are affixed to the side wall 1 are disposed outside a vertical projection region of the elevator car 6. As shown in FIG. 2, the vertical projection region is indicated by cross-lines. This arrangement implements convenient repair of the elevator car 6 and improves security of the elevator.

The side cross section of the housing 2 is square, as shown in FIG. 2. In other embodiments, the cross section of the housing 2 may be circular, triangular, or elliptical.

A mid-axis connecting the stator, the rotor, and the traction sheave 3 is parallel to an axis of rotation of the housing 2 which intersects the side walls 1, so as to facilitate vertical arrangement of the diversion sheaves 5 and the counterweight diversion sheave 7, and to reduce space occupied by the elevator car 6 and the counterweight 8. In another embodiment, the mid-axis connecting the stator, the rotor and the traction sheave 3 coincides with that of the housing 2.

Since the housing 2 operates as a bearing beam of the elevator car 6 and the counterweight 8, a conventional machine room is not needed, which greatly increases the space utilization ratio in the hoistway, reduces the height of the top floor of a building, and conserves building materials.

The traction drive elevator of the invention is applicable to any place suitable for installing traditional elevators, and is particularly applicable to spaces insufficient to install conventional elevators having machine rooms. The requirement for a relatively tall ceiling of the top floor is reduced, which saves building materials and cost. In addition, since vertical dimensions of the elevator can be reduced, working space on the elevator car roof is increased.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

The invention claimed is:

1. An elevator, comprising
an elevator car;
a pair of guide rails;
a counterweight having a counterweight sheave;
a traction drive motor comprising a housing, a stator, a rotor, and a traction sheave;
wherein
said guide rails are disposed in a hoistway;
two ends of said housing are symmetrically fixed to a side wall of the hoistway;
said housing serves as a bearing beam to hold the weight of the elevator car and the counterweight; and
said elevator car and said counterweight are suspended on said traction sheave via a plurality of wire ropes.

2. The elevator of claim 1, wherein points of attachment of said housing to said side wall are disposed outside a vertical projection region of said elevator car.

3. The elevator of claim 2, wherein said housing is a hollow column.

4. The elevator of claim 3, wherein a cross section of said housing is square, circular, triangular, or elliptical.

5. The elevator of claim 4, wherein a mid-axis connecting said stator, said rotor and said traction sheave is parallel to a mid-axis of said housing.

6. The elevator of claim 5, wherein a damping rubber pad is disposed between said housing and said side wall.

7. The elevator of claim 4, wherein a mid-axis connecting said stator, said rotor and said traction sheave coincides with a mid-axis of said housing.

8. The elevator of claim 7, wherein a damping rubber pad is disposed between said housing and said side wall.

9. The elevator of claim 1, wherein a mid-axis connecting said stator, said rotor and said traction sheave is parallel to a mid-axis of said housing.

10. The elevator of claim 1, wherein a mid-axis connecting said stator, said rotor and said traction sheave coincides with a mid-axis of said housing.

11. The elevator of claim 1, wherein a damping rubber pad is disposed between said housing and said side wall.

12. The elevator of claim 1, further comprising a main anchor, an auxiliary anchor, and diversion sheaves, wherein one end of the wire ropes is fixed to said auxiliary anchor; the wire ropes pass through said counterweight sheave, said traction sheave, and said diversion sheaves; and the other end of said wire rope is fixed to said main anchor.
